(19) United States
(12) Patent Application Publication
(10) Pub. No.: US 2026/0077234 A1
(43) Pub. Date: Mar. 19, 2026

(54) METHOD FOR EVALUATING POSE IN STANDING LONG JUMP, ELECTRONIC DEVICE, AND STORAGE MEDIUM

(71) Applicant: Beijing Baidu Netcom Science Technology Co., Ltd., Beijing (CN)

(72) Inventors: Feixiang LU, Beijing (CN); Yihao LV, Beijing (CN); Haotian PENG, Beijing (CN); Longteng LI, Beijing (CN); He JIANG, Beijing (CN)

(21) Appl. No.: 19/402,265

(22) Filed: Nov. 26, 2025

(30) Foreign Application Priority Data
Jun. 30, 2025 (CN) 202510900148.9

(51) Int. Cl. A63B 24/00; G06T 7/246; G06T 7/73; G06V 20/40; G06V 40/20

(52) U.S. Cl. CPC A63B 24/0062; G06T 7/246; G06T 7/73; G06V 20/42; G06V 20/46; G06V 40/23; A63B 2024/0068; A63B 2220/05; A63B 2220/806; A63B 2230/62; A63B 2244/082; G06T 2207/10016; G06T 2207/30196; G06T 2207/30221

(57) ABSTRACT

Provided is a method for evaluating pose in standing long jump, an electronic device, and a storage medium, relating to the field of computer vision applicable to scenarios of physical education, fitness testing, and training for adolescents. The method includes: generating, for a video frame in a standing long jump video of a target object, a body spatial position, a joint angle, a relative position parameter of a body part and a body moving velocity of the target object in the video frame; extracting key motion frames from the standing long jump video; obtaining a key motion evaluation result of the target object in a key motion frame; and determining a standing long jump pose evaluation result according to the key motion evaluation result of the target object.

### CROSS-REFERENCE TO RELATED APPLICATIONS

The present application claims priority to Chinese Patent Application No. CN202510900148.9, filed with the China National Intellectual Property Administration on Jun. 30, 2025, the disclosure of which is hereby incorporated herein by reference in its entirety.

### TECHNICAL FIELD

The present disclosure relates to the field of image processing technologies, especially to the field of computer vision applicable to scenarios of physical education, fitness testing, and training for adolescents, and in particular, to a method and apparatus for evaluating pose in standing long jump, an electronic device, and a storage medium.

### BACKGROUND

The standing long jump is an important athletic event used to assess lower-body explosive power and movement coordination. Its pose evaluation during the standing long jump is crucial for identifying technical flaws, optimizing training programs, and enhancing athletic performance. Currently, evaluation primarily relies on manual observation and expert judgment, in which coaches or specialists subjectively score performance based on video recordings or live observation. This approach is inefficient, highly dependent on individual experience, and prone to inconsistent results. Although sensor-based or image processing-based solutions can improve objectivity, they typically require expensive hardware or complex setups, limiting their widespread adoption. There is therefore an urgent need for a more efficient and convenient evaluation method.

### SUMMARY

The disclosure provides a method and apparatus of evaluating pose in standing long jump, an electronic device, and a storage medium.

According to a first aspect, provided is a method of evaluating pose in standing long jump, including: generating, for a video frame in a standing long jump video of a target object, a body spatial position, a joint angle, a relative position parameter of a body part and a body moving velocity of the target object in the video frame using a body pose estimation method; extracting a plurality of key motion frames from the standing long jump video according to the body spatial position, the body moving velocity and the joint angle of the target object in video frames; obtaining a key motion evaluation result of the target object in a key motion frame according to a preset standard pose parameter, and the relative position parameter of the body part, the body moving velocity and the joint angle of the target object in the key motion frame; and determining a standing long jump pose evaluation result for the target object according to the key motion evaluation result of the target object, where the target object includes, but is not limited to, adolescents.

According to a second aspect of the present disclosure, provided is an electronic device, including: at least one processor; and a memory connected in communication with the at least one processor. The memory stores an instruction executable by the at least one processor, and the instruction, when executed by the at least one processor, enables the at least one processor to execute the method of any embodiment of the present disclosure.

According to a third aspect of the present disclosure, provided is a non-transitory computer-readable storage medium storing a computer instruction thereon, and the computer instruction is used to cause a computer to execute the method of any embodiment of the present disclosure.

It should be understood that the content described in this part is not intended to identify critical or essential features of embodiments of the present disclosure, nor is it used to limit the scope of the present disclosure. Other features of the present disclosure will be easily understood through the following description.

### BRIEF DESCRIPTION OF THE DRAWINGS

The accompanying drawings are used to better understand the present solution, and do not constitute a limitation to the present disclosure, in which:

FIG. 1 is a schematic flowchart of a method of evaluating pose in a standing long jump according to an embodiment of the present disclosure;

FIG. 2 is a schematic diagram of a preparation frame according to an embodiment of the present disclosure;

FIG. 3 is a schematic diagram of a take-off frame according to an embodiment of the present disclosure;

FIG. 4 is a schematic diagram of a flight motion frame according to an embodiment of the present disclosure;

FIG. 5 is a schematic diagram of a landing frame according to an embodiment of the present disclosure;

FIG. 6 is a block diagram of an apparatus of evaluating pose in a standing long jump according to an embodiment of the present disclosure;

FIG. 7 is a schematic diagram illustrating a scenario of the method of evaluating pose in the standing long jump according to the embodiment of the present disclosure;

FIG. 8 is a block diagram illustrating an electronic device for implementing the method of evaluating pose in the standing long jump according to the embodiment of the present disclosure.

### DETAILED DESCRIPTION

Hereinafter, descriptions to exemplary embodiments of the present disclosure are made with reference to the accompanying drawings, include various details of the embodiments of the present disclosure to facilitate understanding, and should be considered as merely exemplary. Therefore, those having ordinary skill in the art should realize, various changes and modifications may be made to the embodiments described herein, without departing from the scope and spirit of the present disclosure. Likewise, for clarity and conciseness, descriptions of well-known functions and structures are omitted in the following descriptions.

The term “and/or” herein only describes an association relation of associated objects, which indicates that there may be three kinds of relations. For example, A and/or B may indicate that there is only A exists, or there are both A and B exist, or there is only B exists. The term “at least one” herein indicates any one of many items, or any combination of at least two of the many items. For example, at least one of A, B, or C may indicate any one or more elements selected from a set of A, B, and C. The term “first” and “second” herein indicate a plurality of similar technical terms and use to distinguish them from each other, but do not limit an order of them or limit that there are only two items. For example, a first feature and a second feature indicate two types of features/two features, a quantity of the first feature may be one or more, and a quantity of the second feature may also be one or more.

In addition, in order to better illustrate the present disclosure, numerous specific details are given in the following specific implementations. Those having ordinary skill in the art should be understood that the present disclosure may be performed without certain specific details. In some examples, methods, means, elements and circuits well known to those having ordinary skill in the art are not described in detail, in order to highlight the subject matter of the present disclosure.

Before the technical solutions of the embodiments of the present disclosure are introduced, technical terms that may be used in the present disclosure are further defined as follows:

Standing long jump: The standing long jump is fundamental track and field athletics primarily used to assess lower-body explosive power and whole-body coordination. It requires that the participant stands at a designated takeoff point and performs a simultaneous two-footed takeoff, to achieve maximum horizontal distance through coordinated body movement and explosive force and complete the jump by landing on both feet simultaneously.

In the related art, existing approaches primarily rely on manual observation and expert judgment to evaluate the quality of standing long jump performance for adolescents. Coaches or specialists score the movement of the standing long jump based on experience and standardized criteria such as the Test of Gross Motor Development (TGMD), using video recordings or live observation. However, this approach suffers from high subjectivity, low efficiency, and inconsistent results. Further, in recent years, some studies have attempted to capture and analyze human motion data using sensor-based systems or advanced image processing techniques. Nevertheless, these approaches typically require expensive hardware or complex setup procedures.

In order to at least partially address one or more of the above problems and other potential problems, the present disclosure proposes a method for evaluating pose in a standing long jump, which parameterizes the pose of a target object performing a standing long jump based on video and performs automated data analysis, thereby improving the consistency and accuracy of an evaluation result. It should be noted that the target object includes, but is not limited to, adolescents, and is also applicable to individuals of other age groups, such as children, adults, and athletes. The method is particularly suitable for scenarios of physical education, fitness assessment and training involving adolescents, which can provide real-time evaluation and feedback on quality of the motion, thereby assisting in the improvement of their jumping skills and athletic performances.

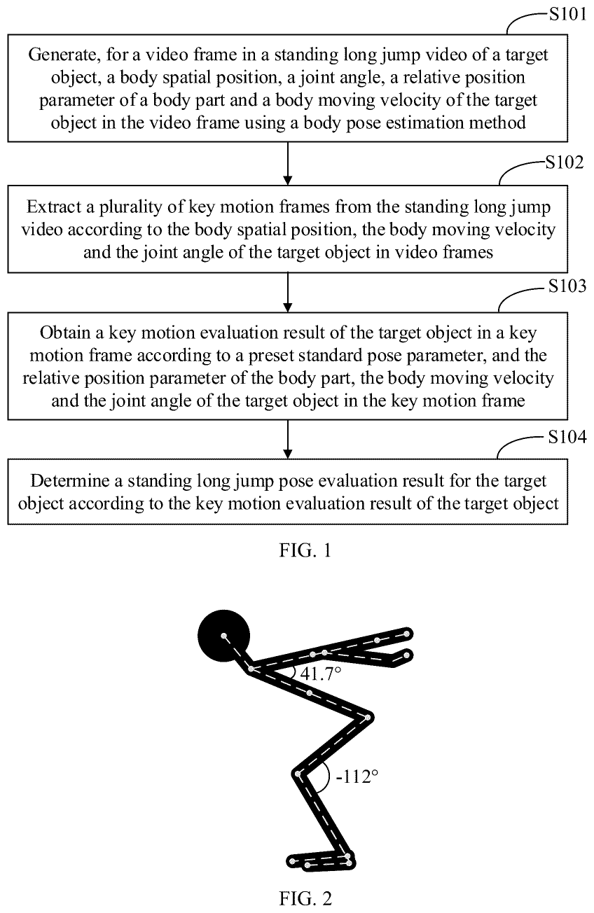

An embodiment of the present disclosure provides a method of evaluating pose in a standing long jump. FIG. 1 is a schematic flowchart of a method of evaluating pose in the standing long jump according to the embodiment of the present disclosure, which is applicable to an apparatus of evaluating pose in the standing long jump deployed on an electronic device. The electronic device includes, but is not limited to, a fixed device and/or a mobile device. For example, the fixed device may include a server, such as a cloud server or a general server. The mobile device may include a motion monitoring device, such as a smartphone, a tablet computer, and an in-vehicle terminal. In some possible implementations, the method of evaluating pose in the standing long jump may be implemented by a processor invoking a computer-readable instruction stored in a memory. As shown in FIG. 1, the method of evaluating pose in the standing long jump includes:
S101: generating, for a video frame in a standing long jump video of a target object, a body spatial position, a joint angle, a relative position parameter of a body part and a body moving velocity of the target object in the video frame using a body pose estimation method;
S102: extracting a plurality of key motion frames from the standing long jump video according to the body spatial position, the body moving velocity and the joint angle of the target object in video frames;
S103: obtaining a key motion evaluation result of the target object in a key motion frame according to a preset standard pose parameter, and the relative position parameter of the body part, the body moving velocity and the joint angle of the target object in the key motion frame; and
S104: determining a standing long jump pose evaluation result for the target object according to the key motion evaluation result of the target object.

The standing long jump video is a video for recording a standing long jump motion of the target object. In the embodiment of the present disclosure, the standing long jump video records a complete standing long jump motion and can be stored in hard disk.

The body pose estimation method is a method for extracting the positions and postures of key points of a body skeleton through images or videos. In the embodiment of the present disclosure, the body pose estimation method may be an open-sourcing continuous frame body pose estimation method (Trajectory and Motion of 3 Dimensional Humans, TRAM).

The body spatial position refers to a position coordinate of the body in a three-dimensional or two-dimensional space. In the embodiment of the present disclosure, the body spatial position may be a position coordinate of a root node of the body in the three-dimensional or two-dimensional space. In particular, the root node may be a skeletal center or reference point of the human body. Specifically, the root node of the human body may be a pelvic node of the human body.

The joint angle refers to an angle between adjacent bones. In the embodiment of the present disclosure, the joint angle may be a spatial angle of bone connection points in the body skeleton.

The relative position parameter of the body part is used for indicating a relative position relation between body parts. In the embodiment of the present disclosure, the relative position parameter of the body part may include the spatial position relationship between the parts of the body and the spatial angle between the parts of the body that are not directly connected.

The body moving velocity refers to a velocity of the body part moving in space. In the embodiment of the present disclosure, the body moving velocity can include a movement velocity of a body joint and an angular velocity of the body joint.

In the embodiment of the present disclosure, the standing long jump video of the target object may be obtained first. In particular, the definition and stability of the standing long jump video can be improved through the preprocessing operation. Subsequently, the body pose estimation method can be used for detecting the key points of the body skeleton for each frame, and further extracting the body spatial position, the joint angle, the relative position parameter of the body part and the body moving velocity in the frame. The above is merely exemplary and not intended to be exhaustive as to all possible situations of generating the body spatial position, the joint angle, the relative position parameter of the body part and the body moving velocity.

The key motion frame is an important motion node in the process of the standing long jump. In the embodiment of the present disclosure, the key motion frame can reflect an important pose or motion of the target object in the process of completing the standing long jump.

In the embodiment of the present disclosure, the key motion frame can be determined according to the body spatial position, the motion velocity of the body and the joint angle. For example, the standing long jump motion may be analyzed and the extraction rule of the key motion frame may be defined according to the human kinematics rule. The above is merely exemplary and not intended to be exhaustive as to all possible situations of extracting the plurality of key motion frames.

The preset standard pose parameter refers to a reference parameter predefined based on kinematic theory, professional coaching standards, or practical experience, and is used to assess the correctness and technical quality of the motion. In the embodiment of the present disclosure, the standard pose parameter specifies specific indicators such as a body posture, a joint angle, a motion velocity, a relative position of a body part which should be achieved at a key motion node of the target motion under an ideal condition.

The key motion evaluation result is a result of evaluating a motion performance of the target object in a certain specific key motion frame. In the embodiment of the present disclosure, the key motion evaluation result can reflect whether a pose of the target object when completing a certain motion meets the preset standard pose requirement.

In the embodiment of the present disclosure, the relative position parameter of the body part, the motion velocity of the body and the joint angle corresponding to the key motion frame may be compared with preset standard parameters. An evaluation score or result for a motion may then be generated based on the motion deviation magnitude. The above is merely exemplary and not intended to be exhaustive as to all possible situations of obtaining the key motion evaluation result.

The evaluation result of the pose in the standing long jump is an overall motion evaluation obtained by integrating the key motion evaluation results. In the embodiment of the present disclosure, the evaluation result of the standing long jump pose can integrate the motion quality, technical standardization and performance correctness of the target object in different key motions, and an overall conclusion is generated according to the key motion evaluation results.

In the embodiment of the present disclosure, a composite score or evaluation may be generated according to the evaluation result of each key motion frame. Subsequently, an overall evaluation report can be generated, including scoring, problem analysis, and optimization recommendations. The above is merely exemplary and not intended to be exhaustive as to all possible situations of determining the evaluation result of the standing long jump posture.

In the embodiment of the present disclosure, the target object refers to any person who performs the standing long jump.

It should be noted that the target object includes, but is not limited to, adolescents, and is also applicable to a user of other ages (e.g., children, adults, or athletes).

The technical solution according to the embodiment of the present disclosure enables the acquisition of various body motion data solely from the standing long jump video through the body pose estimation, without requiring wearable sensors and applicably to body movement analysis across diverse scenarios. By extracting key motion frames, the method reduces data redundancy and focuses on critical motion notes of the movement, while providing essential kinematic information to support pose analysis. The generation of key motion evaluation result can provide a quality evaluation of each critical motion. The generation of the overall evaluation result of the standing long jump pose can provide an overall performance assessment, helping a user understand their movement quality. The method of evaluating the pose in the standing long jump according to the disclosure addresses the problem of motion evaluation faced by adolescents during the learning, testing, and training of the standing long jump, which is especially suitable for the scenarios in adolescent physical education, fitness test, and training. The method provides the real-time feedback on movement correctness, thereby assisting adolescents in improving their jumping technique and athletic performance. As such, the method has significant practical value in adolescent education, health monitoring and skill development.

In some embodiments, generating, for the video frame in the standing long jump video of the target object, the body spatial position, the joint angle, the relative position parameter of the body part, and the body moving velocity of the target object in the video frame using the body pose estimation method includes: generating, for the video frame, a body parameterized model and the body spatial position of the target object in the video frame using the body pose estimation method; determining a key point spatial position, the joint angle and the relative position parameter of the body part in the video frame according to the body parameterized model and the body spatial position; and determining the body moving velocity in the video frame based on a sampling parameter according to the key point spatial position.

The body parameterized model is used for modeling body bones and joints in a mathematical mode and includes a relationship between the key points and the connecting points. In the embodiment of the present disclosure, the body parameterized model may be a Skinned Multi Person Linear (SMPL) model.

In the embodiment of the present disclosure, the body pose estimation method can be used for detecting a frame of the key points of the body skeleton, and further extracting a two-dimensional or three-dimensional model of the body. Subsequently, positions and connection relations of the key points of the body skeleton can be converted into the parameterized model, and the spatial position of the body is output by using the model. The above is merely exemplary and not intended to be exhaustive as to all possible situations of generating the body parameterized model and the body spatial position.

The key point spatial position refers to a spatial coordinate of the key point of the body. In the embodiment of the present disclosure, the number and the selection of the key points may be selected according to the number and the positions preset in the body parameterized model. Illustratively, when the SMPL model is employed, a default of 24 key points of the body may be selected.

In the embodiment of the present disclosure, the position of the bone key point for a frame may be first extracted from the body parameterized model. The joint angle may then be calculated from the key point coordinates. Finally, the relative position between the body parts can be calculated based on the spatial coordinates to obtain the relative position parameter of the body parts. The above is merely exemplary and not intended to be exhaustive as to all possible situations of generating the key point spatial position, the joint angle and the relative position parameter of body part.

The sampling parameter refers to a time interval or sampling rate for analyzing the video frame. In the embodiment of the present disclosure, the sampling parameter may be a frame rate of the standing long jump video, or may be a time interval for analyzing the video frame.

In the embodiment of the present disclosure, a moving velocity of the key point can be calculated by using the key point spatial position in any frame and the previous frame in time sequence based on the time interval of the video frame. Meanwhile, an angular velocity of the joint can be calculated by using a value of the joint angle in any frame and the previous frame in the time sequence based on the time interval of the video frame. The above is merely exemplary and not intended to be exhaustive as to all possible situations of determining the body moving velocity.

As such, by generating the body parameterized model and the key point spatial position of the target object using the body pose estimation method, the motion data of the body in the video frame can be accurately extracted, and the body pose of the target object is truly reflected. Through multi-dimensional information such as the spatial position, the joint angle, the relative position of the body part and the moving velocity, a motion state of the target object can be comprehensively evaluated, so that details in the motion can be accurately captured. The process of extracting the body moving velocity from the video frame allows a motion change trend of the target object to be dynamically captured. The body pose estimation method and the parameterized model can be used to automatically process the motion data in the video frame, thereby avoiding the problems of low efficiency and high error of the traditional manual labeling.

In some embodiments, determining the key point spatial position, the joint angle and the relative position parameter of body part in the video frame according to the body parameterized model and the body spatial position includes: determining a pose parameter and a body shape parameter according to the body parameterized model; determining the key point spatial position according to the pose parameter, the body shape parameter and the body spatial position; determining a body skeleton vector according to the key point spatial position; and determining the joint angle and the relative position parameter of the body part according to the body skeleton vector.

The pose parameter is a group of information describing the relative spatial position of the body part and is used for defining the pose of the body motion. In the embodiment of the present disclosure, the pose parameter may be a joint rotation amount parameter of SMPL, which can be used to indicate a joint angle and a bone direction, for example.

The body shape parameter is characteristic information describing the whole shape of the body. In the embodiment of the present disclosure, the body shape parameter may be a body shape parameter of SMPL, which can be used to indicate a body shape such as height, figure and proportion, for example.

In the embodiment of the present disclosure, the key points of the body skeleton can be extracted from the standing long jump video by using the body pose estimation method, and the body skeleton model is parameterized to generate an integral mathematical model. Subsequently, the characteristics reflecting the motion pose of the body can be extracted as the pose parameter by analyzing the joint angle and the position and direction of the bones of the body. Then, overall shape characteristics of the body can be calculated as the body shape parameter. The above is merely exemplary and not intended to be exhaustive as to all possible situations of determining the pose parameter and the body shape parameter.

In the embodiment of the present disclosure, a spatial coordinate of a key point may be first extracted from the video frame by using a pose estimation algorithm. Subsequently, the relative position of the key point can be adjusted according to the pose parameter to enable the skeleton model to follow body motion logic. Finally, the overall shape of the key points can be optimized according to the body shape parameter. The above is merely exemplary and not intended to be exhaustive as to all possible situations of determining the key point spatial position.

The body skeleton vector refers to a vector of a connection relation between parts of the body skeleton. In the embodiment of the present disclosure, the body skeleton vector may be a spatial position difference between two key points.

In the embodiment of the present disclosure, the skeleton vector may be first calculated according to the spatial coordinate of the key point. Subsequently, a spatial length and direction of the vector can be used to represent motion characteristic of the body skeleton. The above is merely exemplary and not intended to be exhaustive as to all possible situations of determining the body skeletal vector.

In the embodiment of the present disclosure, an angle may be calculated according to directions of two skeleton vectors. Illustratively, the angle between the two skeleton vectors can be calculated using the cosine theorem. Subsequently, a distance, a position ratio, a relative position and an included angle between the body parts can be calculated according to the position of the key point. The above is merely exemplary and not intended to be exhaustive as to all possible situations of determining the joint angle and the relative position parameter of the body part.

As such, the motion state and the body characteristics of the body can be comprehensively described by determining the pose parameter and the body shape parameter. By determining the key point spatial position, an accurate spatial coordinate of the key point of the body skeleton can be provided, and the combination of the pose parameter and the body shape parameter makes the spatial position more in line with the actual body state. By determining the body skeleton vector, the connection relation between the body parts can be clarified and the overall continuity of the motion can be reflected. By determining the joint angle and the relative position parameter of the body part, the bending degree of the joint and the relative position of the body part can be reflected and the motion details can be visually shown.

In some embodiments, extracting the plurality of key motion frames from the standing long jump video according to the body spatial position, the body moving velocity and the joint angle of the target object in the video frame includes: extracting a preparatory motion frame from the standing long jump video according to the joint angle of the target object in the video frames; extracting a take-off motion frame from the standing long jump video according to the body moving velocity of the target object in the video frame; extracting a flight motion frame from the standing long jump video according to the body spatial position of the target object in the video frame; and extracting a landing motion frame from the standing long jump video according to the body moving velocity of the target object in the video frame and the take-off motion frame.

The key motion frame is an important motion node in the process of the standing long jump. In an embodiment of the present disclosure, the key motion frames include at least the preparatory motion frame, the take-off motion frame, the flight motion frame and the landing motion frame.

The preparatory motion frame refers to a frame corresponding to a pose where the body is in a squatting position or is preparing to generate propulsive force.

The take-off motion frame refers to a frame corresponding to the moment when the body takes off from the ground.

The flight motion frame is a frame corresponding to a position where the body is in the air and reaches the highest point.

The landing motion frame is a frame corresponding to a pose where the body contacts the ground with the motion completed.

In the embodiment of the present disclosure, as can be seen from the analysis of the motions of the standing long jump, the preparatory motion is usually represented as squat of the body, a smaller included angle of the knee joint and a static state of the shoulder joint. Therefore, the frame having the smallest included angle of the knee joint is used as a preparatory motion frame, the included angle of the knee joint as a judgment condition. Further, to accurately find the preparatory motion frame, constraints may be added to narrow the selection. Illustratively, frames before the take-off motion frame can be used as candidate video frames from which the preparatory motion frame is selected, so that the correct preparatory motion frame is accurately selected. The above is merely exemplary and not intended to be exhaustive as to all possible situations of determining the preparatory motion frame.

In the embodiment of the present disclosure, as can be seen from the analysis of the motions of the standing long jump, the take-off motion is represented as rapid acceleration and a suddenly increasing velocity of the body. Therefore, the frame in which the body moving velocity starts to increase is used as the take-off motion frame, with the body moving velocity as the judgment condition. Illustratively, a frame can be found, from which a moving velocity of the following continuous frames is higher than an average velocity of all the previous frames, and then the frame is determined to be the take-off motion frame. The above is merely exemplary and not intended to be exhaustive as to all possible situations of determining of the take-off motion frame.

In the embodiment of the present disclosure, as can be seen from the analysis of the motions of the standing long jump, the flight motion is represented as the body being moving away from the ground and reaching the highest point. Therefore, the frame with the highest body spatial position can be used as the flight motion frame, with the body spatial position as a judgment condition. Illustratively, the frame with the highest body spatial position in the z-axis can be found as the flight motion frame. The above is merely exemplary and not intended to be exhaustive as to all possible situations of determining of the flight motion frame.

In the embodiment of the present disclosure, as can be seen from the analysis of the motions of the standing long jump, the landing motion is represented as rapid acceleration and a suddenly reducing velocity of the body. Therefore, the frame in which the body velocity starts to decrease is used as the landing motion frame, with the body moving velocity as a judgment condition. Illustratively, a frame may be found, from which the moving velocity of the following continuous frames is lower than an average velocity of all the previous frames, and then the frame may be determined to be the landing motion frame. Particularly, frames after the take-off motion frame can be used as candidate video frames from which the landing motion frame is selected, so that the correct landing motion frame is ensured to be accurately selected. The above is merely exemplary and not intended to be exhaustive as to all possible situations of determining the landing motion frame.

As such, the determination of the preparatory motion frame through the joint angle can automatically identify the preparatory pose and ensure motion classification accuracy. The determination of the take-off motion frame through the body moving velocity can identify the initial motion of jumping, accurately position the key point of the motion, and reduce unnecessary redundant data analysis by using the velocity change characteristic. The determination of the flight motion frame through the body spatial position can automatically identify the flight motion to avoid any human error. The determination of the landing motion frame through the body moving velocity and the take-off motion frame can automatically identify the landing motion, and in the meanwhile, a continuous motion chain combining four key motions of preparatory, take-off, flight and landing motions is formed for the integral evaluation.

In some embodiments, obtaining the key motion evaluation result of the target object in the key motion frame according to the preset standard pose parameter and the relative position parameter of the body part, the body moving velocity and the joint angle of the target object in the key motion frame, includes: determining body pose data of the target object in the key motion frame according to the relative position parameter of the body part, the body moving velocity and the joint angle; and comparing the body pose data with the standard pose parameter to obtain the key motion evaluation result of the target object in the key motion frame.

The body pose data is information of a motion state of the body in a specific motion. In the embodiment of the present disclosure, the body pose data includes at least one or more values of the relative position parameter of the body part, the body moving velocity and the joint angle. In the embodiment of the present disclosure, the relative position parameter of the body part, the body moving velocity, and the joint angle of each key motion frame may be obtained; subsequently, the data concerned by the key motion frame is extracted; and the required data is integrated into the body pose data corresponding to the key motion frame. The above is merely exemplary and not intended to be exhaustive as to all possible situations of determining the body pose data.

The standard pose parameter is a preset group of reference data used for describing the characteristics of the body motions or poses in an ideal state. In the embodiment of the present disclosure, the standard pose parameter may select a standing long jump standard in the TGMD.

In the embodiment of the present disclosure, data concerned by the key motion frame may be compared with a corresponding value in the standard pose parameter, and an evaluation result of the key motion frame is generated according to a comparison result. The above is merely exemplary and not intended to be exhaustive as to all possible situations of obtaining the key motion evaluation result.

As such, the determination of the body pose data corresponding to the key motion frame can convert complex motion information into the quantifiable body pose data, and provide detailed pose data covering positions, velocity and angles, which can completely describe the state of a specific motion. The obtaining the key motion evaluation result corresponding to the key motion frame can quantitatively compare the body pose with the standard parameter, can identify the problem in the key motion, and can provide an objective evaluation result.

In some embodiments, determining the body pose data of the target object in the key motion frame according to the relative position parameter of the body part, the body moving velocity and the joint angle includes: determining the body pose data of the target object in the preparatory motion frame according to the joint angle and the relative position parameter of the body part; determining the body pose data of the target object in the take-off motion frame according to the relative position parameter of the body part and the body moving velocity; determining the body pose data of the target object in the flight motion frame according to the relative position parameter of the body part; and determining the body pose data of the target object in the landing motion frame according to the relative position parameter of the body part and the body moving velocity.

In the embodiment of the present disclosure, as can be seen from the analysis of the motions of the standing long jump, the preparatory motion needs to focus on the squatting amplitude. Therefore, the included angle of the knee joint can be extracted from the joint angle corresponding to the preparatory motion frame. Further, the preparatory motion also focuses on whether the arms are behind the body. Therefore, a relative position and an included angle between the arm and the trunk can be extracted from the relative position parameter of the body part corresponding to the preparatory motion frame. Finally, the included angle of the knee joint and the relative position and the included angle between the arm and the trunk is used as the body pose data corresponding to the preparatory motion frame. The above is merely exemplary and not intended to be exhaustive as to all possible situations of determining the body pose data of the target object in the preparatory motion frame.

In the embodiment of the present disclosure, as can be seen from the analysis of the motions of the standing long jump, the take-off motion needs to focus on whether the arms are forcefully stretched forwards. Therefore, the relative position and the included angle between the arm and the trunk can be extracted from the relative position parameter of the body part corresponding to the take-off motion frame. Further, the take-off motion also focuses on whether the arms are forcefully swung forwards. Therefore, the relative position and the included angle between the arm and the trunk can be extracted from the relative position parameters of the body part corresponding to the take-off motion frame and a plurality of frames before the take-off motion frame in the time sequence, and the judgment is carried out based on a change trend of the included angles in the plurality of frames. Furthermore, the take-off motion also requires attention to whether both feet are simultaneously taking off. Therefore, the velocity of both feet can be extracted from the body moving velocity corresponding to the take-off motion frame, and the judgment can be made by a velocity difference between both feet. Finally, the relative position and the included angle between the arm and the trunk and the velocity of the feet are used as the body pose data corresponding to the take-off motion frame. The above is merely exemplary and not intended to be exhaustive as to all possible situations of determining the body pose data of the target object in the take-off motion frame.

In the embodiment of the present disclosure, as can be seen from the analysis of the motions of the standing long jump, the flight motion needs to focus on whether the hands are extended overhead. Therefore, relative positions between the two-hands and the head can be extracted from the relative position parameter of the body part corresponding to the flight motion frame. Finally, the relative positions of the two-hands and the head are used as the body pose data corresponding to the flight motion frame. The above is merely exemplary and not intended to be exhaustive as to all possible situations of determining the body pose data of the target object in the flight motion frame.

In the embodiment of the present disclosure, as can be seen from the analysis of the motions of the standing long jump, the landing motion needs to focus on whether the arm forcefully swings backwards. Therefore, the relative position and the included angle between the arm and the trunk can be extracted from the relative position parameter of the body part corresponding to the landing motion frame and a plurality of frames after the landing motion frame in the time sequence, and the judgment is carried out based on a change trend of the included angles in the plurality of frames. Further, the landing motion also focuses on whether both feet land simultaneously. Therefore, the velocity of both feet can be extracted from the body moving velocity corresponding to the landing motion frame, and the judgment can be made by the velocity difference between both feet. Finally, the velocity of the feet, and the relative position and the included angle between the arm and the trunk are used as the body pose data corresponding to the landing motion frame. The above is merely exemplary and not intended to be exhaustive as to all possible situations of determining the body pose data of the target object in the landing motion frame.

As such, the determination of the pose data of the preparatory motion, the take-off motion, the flight motion and the landing motion can cover multi-dimensional information such as the position, the velocity and the angle, can completely describe the motion process, and can provide the characteristic data of the key motions.

In some embodiments, comparing the body pose data with the standard pose parameter to obtain the key motion evaluation result of the target object in the key motion frame, includes: comparing the body pose data of the target object in the preparatory motion frame with standard preparatory pose parameter to obtain the key motion evaluation result of the target object in the preparatory motion frame; comparing the body pose data of the target object in the take-off motion frame with standard take-off pose parameter to obtain the key motion evaluation result of the target object in the take-off motion frame; comparing the body pose data of the target object in the flight motion frame with standard flight pose parameter to obtain the key motion evaluation result of the target object in the flight motion frame; and comparing the body pose data of the target object in the landing motion frame with standard landing pose parameter to obtain the key motion evaluation result of the target object in the landing motion frame.

The standard preparatory pose parameter refers to pose characteristic of the body in preparatory motion under the ideal condition. In the embodiment of the present disclosure, the standard preparatory pose parameter refers to standard pose data of the preparatory motion in the standing long jump in the TGMD.

In the embodiment of the present disclosure, an included angle threshold of the knee joint and an included angle threshold between the arm and the trunk is determined according to the standard preparatory pose parameter, the included angle of the knee joint of the target object in the body pose data in the preparatory motion frame is compared with the included angle threshold of the knee joint, the included angle between the arm and the trunk of the target object in the body pose data in the preparatory motion frame is compared with the included angle threshold between the arm and the trunk, and whether the relative position between the arm and the trunk is such that the arm is behind the trunk is judged. Finally, the evaluation result is generated based on the differences. The above is merely exemplary and not intended to be exhaustive as to all possible situations of obtaining the key motion evaluation result of the target object in the preparatory motion frame.

The standard take-off pose parameter refers to pose characteristic of the body in take-off motion under the ideal condition. In the embodiment of the present disclosure, the standard take-off pose parameter refers to standard pose data of the take-off motion in the standing long jump in the TGMD.

In the embodiment of the present disclosure, an included angle threshold between the arm and the trunk and a two-foot velocity difference threshold are determined according to the standard take-off pose parameter, the included angle between the arm and the trunk in the body pose data of the target object in the take-off motion frame is compared with the included angle threshold between the arm and the trunk, and whether the relative position between the arm and the trunk is such that the arm is behind the trunk is judged. Meanwhile, whether the change trend of the included angles of the plurality of frames is gradually increased is judged according to the relative positions and the included angles between the arm and the trunk corresponding to the take-off motion frame and the frames before the take-off motion frame in the time sequence. Subsequently, the two-foot velocity difference can be calculated according to the two-foot velocity of the target object in the body pose data in the take-off motion frame, and the two-foot velocity difference is compared with the two-foot velocity difference threshold. Finally, the evaluation result is generated based on the difference. The above is merely exemplary and not intended to be exhaustive as to all possible situations of obtaining the key motion evaluation result of the target object in the take-off motion frame.

The standard flight pose parameter refers to the pose characteristic of the body in flight motion under the ideal condition. In the embodiment of the present disclosure, the standard flight pose parameter refers to standard pose data of the flight motion in the standing long jump in the TGMD.

In the embodiment of the present disclosure, a relative position difference threshold between the two-hands and the head is determined according to the standard flight pose parameter. Subsequently, an included angle of the knee joint is calculated according to the relative position between the two-hands and the head of the target object in the body pose data in the flight motion frame and is compared with the included angle threshold of the knee joint, and meanwhile, the relative position difference between the two-two-hands and the head corresponding to the preparatory motion frame is compared with the relative position difference threshold value between the two-two-hands and the head. Finally, the evaluation result is generated based on the difference. The above is merely exemplary and not intended to be exhaustive as to all possible situations of obtaining the key motion evaluation result of the target object in the flight motion frame.

The standard landing pose parameter refers to the pose characteristic of the landing motion of the body under the ideal condition. In the embodiment of the present disclosure, the standard landing pose parameter refers to standard pose data of the landing motion in the standing long jump in the TGMD.

In the embodiment of the present disclosure, the two-foot velocity difference threshold and a standard angular velocity direction are determined according to the standard landing pose parameter. Subsequently, a two-foot velocity difference is calculated according to the two-foot velocity of the target object in the body pose data in the landing motion frame, and the two-foot velocity difference is compared with the two-foot velocity difference threshold. Meanwhile, whether the angular velocity direction of the included angle of the plurality of frames is consistent with the standard angular velocity direction is judged according to the relative positions and the included angles between the arm and the trunk corresponding to the landing motion frame and the frames after the landing motion frame in the time sequence. Finally, the evaluation result is generated based on the difference. In particular, the angular velocity direction can be determined using the right-hand rule. The above is merely exemplary and not intended to be exhaustive as to all possible situations of obtaining the key motion evaluation result of the target object in the landing motion frame.

As such, by generating the preparatory motion evaluation result, the take-off motion evaluation result, the flight motion evaluation result and the landing motion evaluation result, respectively, it is possible to provide the force exertion and coordination evaluation of the motions, identify the deficiencies in the motions and offer an improvement suggestion.

In some embodiments, determining the standing long jump pose evaluation result for the target object according to the key motion evaluation result of the target object includes: traversing key motion evaluation results of the target object and extracting the correction suggestion in the key motion evaluation results; and generating the standing long jump pose evaluation result according to the correction suggestion and the key motion corresponding to the correction suggestion.

The key motion evaluation result includes at least “qualified” or the correction suggestion. The correction suggestion is specific guidance information generated within the key motion evaluation result, which is used to help a user optimize their motions. In the embodiment of the present disclosure, the correction suggestion is an improvement plan proposed for the motions with a deviation or non-compliance with the standard parameter, based on the comparison result between actual body pose data and the standard pose parameter.

In the embodiment of the present disclosure, the evaluation results of the key motions are traversed first, data with the “qualified” evaluation result is ignored, only the suggestion information included in the evaluation result is screened out, and the correction suggestions in the evaluation results of the key motions are extracted one by one. The above is merely exemplary and not intended to be exhaustive as to all possible situations of extracting the correction suggestion.

In the embodiment of the present disclosure, optimization guidance for the whole motion chain is formed by integrating the correction suggestions of all the key motions. Subsequently, the correction suggestion is associated with a particular key motion. Finally, the correction suggestions of the key motions are integrated into the standing long jump pose evaluation result. The above is merely exemplary and not intended to be exhaustive as to all possible situations of generating the standing long jump pose evaluation result.

As such, the extraction of the correction suggestion in the key motion evaluation result can traverse the key motion evaluation results to ensure that all problematic points are identified. The generation of the standing long jump pose evaluation result can generate a complete motion evaluation result according to the correction suggestions of all key motions, providing an overall feedback for the user.

In some embodiments, after obtaining the key motion evaluation result of the target object in the key motion frame according to the preset standard pose parameter and the relative position parameter of the body part, the body moving velocity and the joint angle of the target object in the key motion frame, the method further includes: weighting the key motion evaluation result according to a confidence parameter output by the body pose estimation method to generate a weighted key motion evaluation result, where the confidence parameter represents an estimation reliability of the body parameterized model and the key point spatial position.

The confidence parameter represents the estimation reliability of the body parameterized model and the key point spatial position. In the pose estimation process, the algorithm gives a confidence score (usually ranged from 0 to 1) to an estimation result of the key point or an overall pose, and a higher score indicates that the estimation result is more reliable.

In the embodiment of the present disclosure, the confidence parameter output by the body pose estimation method and corresponding to the key motion frame is obtained first. Subsequently, a weighted calculation is performed on the key motion evaluation result by using the confidence parameter as a weight factor. For example, for the case that the evaluation result is “correction suggestion”, if the confidence is low (e.g., less than 0.5), the weight of the suggestion may be decreased or the suggestion may be labeled as “low confidence suggestion”; if the confidence is high (e.g., greater than 0.8), the weight of the suggestion is maintained or increased. For the case that the evaluation result is “qualified”, a high confidence may strengthen the effectiveness, and a low confidence may indicate that there may be uncertainty in the result. Finally, the weighted key motion evaluation result is generated based on the weighting result. The above is merely exemplary and not intended to be exhaustive as to all possible situations of the weighting processing method.

As such, the weighting processing on the evaluation result by introducing the confidence parameter can more reasonably reflect the influence of the uncertainty of the pose estimation on the final evaluation conclusion. For the evaluation result (no matter the “qualified” or correction suggestion) obtained by low confidence estimation, the system can give appropriate weight reduction or labeling to avoid any misjudgment caused by a pose estimation error; and for the evaluation result obtained by the high confidence estimation, then enhance the reliability. The objectivity and reliability of the standing long jump pose evaluation result are obviously improved, so that the feedback information has more reference value for the user.

In some embodiments, obtaining the key motion evaluation result of the target object in the key motion frame according to the preset standard pose parameter and the relative position parameter of the body part, the body moving velocity and the joint angle of the target object in the key motion frame, further includes: in the landing motion frame, calculating a gravity center trajectory after landing and a touchdown time according to the body spatial positions of continuous frames; generating a landing stability evaluation result according to a deviation amplitude and direction of the gravity center trajectory and the touchdown time and by combining a preset landing stability standard parameter; and adding the landing stability evaluation result to the key motion evaluation result corresponding to the landing motion frame.

The gravity center trajectory refers to a moving path of the gravity center of the body in space (particularly a horizontal plane) within a period of time after the body lands on the ground; the touchdown time refers to the time that elapses from the first touchdown of the feet to the restoration of the body to a stable standing pose (or cease of significant movement of the gravity center); landing stability standard parameters defines thresholds for maximum allowable amplitude and direction (e.g., forward, backward, and side shift) for gravity center offset and desired touchdown time range.

In the embodiment of the present disclosure, after the landing motion frame is determined, the body spatial position data of the subsequent continuous frames after the landing motion frame may be extracted. The moving track of the gravity center and the amplitude and direction of the gravity center offset on the horizontal plane after the landing is calculated based on the body spatial position data. Meanwhile, a time interval from the landing motion frame to the body recovery stabilization frame is calculated as the touchdown time. Subsequently, the calculated gravity center offset amplitude, the offset direction and the touchdown time are compared and analyzed with preset landing stability standard parameters. For example, if the gravity center offset amplitude is too large or exceeds a threshold, the offset direction is a backward tilt or a lateral shift that is prone to fall, or the touchdown time is too long, a specific landing stability evaluation result such as “unstable landing”, “risk of falling” or “insufficient cushioning” is generated. Finally, the landing stability evaluation result and the landing motion evaluation result previously generated based on the pose parameter are combined or superposed to form a more comprehensive key motion evaluation result corresponding to the landing motion frame. The above is merely exemplary and not intended to be exhaustive as to all possible situations of calculating the gravity center trajectory and the touchdown time and generating the stability evaluation result.

As such, the addition of the evaluations of the gravity center trajectory and the touchdown time after the landing in the analysis of the landing motion frame can more comprehensively capture the quality and the safety of the landing motion. Traditional pose evaluation focuses mainly on body shape at the moment of landing, while the gravity center trajectory and touchdown time reflect body control ability and cushion effect after landing. The incorporation of the landing stability evaluation result allows the final landing motion evaluation result to indicate the pose problem, while pre-warning the potential falling risk, evaluating the cushion efficiency and providing the deeper and more practical landing technical feedback for the user, thereby providing important significance in improving athletic performances and preventing athletic injuries.

In some embodiments, the method of evaluating the pose in the standing long jump further includes: calculating a motion transition time interval between adjacent key motions according to the time sequence of the preparatory motion frame, the take-off motion frame, the flight motion frame and the landing motion frame; generating a motion consistency evaluation result by combining a preset standard motion consistency parameter according to the motion transition time interval and a change rate of the joint angle between corresponding motion frames; and merging the motion consistency evaluation result into the standing long jump pose evaluation result.

The motion transition time interval refers to the time from a key motion frame (such as preparatory end) to the next key motion frame (such as take-off start); the change rate of the joint angle refers to an average rate of an angle change of a specific key joint (such as a knee, a hip and an ankle joint) or a change rate of a specific sub-phase in the time interval; the standard motion consistency parameter defines a time range required for phase transition under the ideal state and a change rate range that the joint angle should have.

In the embodiment of the present disclosure, specific time points of the key motion frames are determined according to the motion occurrence sequence based on timestamp information of a standing long jump video. Subsequently, a time difference between adjacent key motions is calculated to obtain the motion transition time interval (such as a preparatory-take-off motion interval, a take-off-flight motion interval, and a flight-landing motion interval). Meanwhile, joint angle data corresponding to all frames (or key sub-phase frames) between the adjacent key motion frames are extracted, and the change rate of the joint angle in the time interval, such as a stretching average angular velocity of the knee joint in the preparation to take-off phase, is calculated. Next, the calculated motion transition time interval and the change rate of the key joint angle are compared with the preset standard motion consistency parameter. For example, if a certain transition time interval is too long or exceeds a threshold or the change rate of the key joint angle is too low or below a threshold, a specific motion consistency evaluation result such as “slow connection from preparation to take-off”, “insufficient explosive force of kicking and stretching”, or “inactive leg retraction in the air” may be generated. Finally, the motion consistency evaluation result is taken as an independent evaluation dimension, and is merged into the final standing long jump pose evaluation result. The above is merely exemplary and not intended to be exhaustive as to all possible situations of calculating the time interval and the change rate of the joint angle and generating the consistency evaluation result.

As such, the calculation of the time interval of motion phase transition and the change rate of the key joint angle can effectively evaluate the consistency and rhythm of the whole motion process of the standing long jump. Traditional pose estimation based on discrete key motion frames focuses mainly on static or transient body shape, while the present solution focuses on dynamic transition efficiency and exertion characteristics between the motion phases. The motion consistency evaluation result is merged into the final evaluation result, so that the system can not only indicate the pose problem of the key point, but also diagnose whether the motion transition is smooth, the force exertion opportunity is reasonable and the rhythm control is proper, thereby providing valuable feedback about the overall coordination and efficiency of the motion for the user and contributing to comprehensively improving the fluency and the economy of the technical motion.

In some embodiments, the standing long jump video is captured by a monocular camera at a fixed position.

The monocular camera is an image recording device having only one lens, which is used for capturing two-dimensional images or videos.

In the embodiment of the present disclosure, the monocular camera can be installed at a fixed position to ensure the consistency of the shooting angle and the visual field. In particular, camera parameters such as the resolution, frame rate and exposure are configured to ensure that motion details are captured clearly. Subsequently, the monocular camera can be used for capturing the standing long jump video in real time or within a preset time, to record the motion process of the standing long jump. Finally, the captured video is saved as a file with a standard format and is stored to invoke during subsequent analysis. The above is merely exemplary and not intended to be exhaustive as to all possible situations of capturing the standing long jump video.

As such, the standing long jump video can be obtained simply by the monocular camera at the fixed position, and compared with a multi-camera system, the use of the monocular camera has a lower cost and is suitable for large-scale application. Meanwhile, the monocular camera is installed at the fixed position, avoiding image shaking or data loss caused by camera shift.

In some embodiments, data collection may be performed first. Illustratively, the standing long jump process video of the tested adolescent can be captured by the monocular camera at the fixed position and stored in a hard disk. The video contains a complete motion of the standing long jump.

Further, a body reconstruction and physical quantity calculation can be performed. Illustratively, the latest video is read first, and the body pose estimation result and the global displacement may be completed frame by frame in the video by using the TRAM. The pose estimation result is a joint rotation quantity parameter POSE and a body shape parameter SHAPE in the body parametrized model SMPL. A dimension of 24*3 of POSE represents axis-angle rotation amounts of 24 human body joint sites; a dimension of 10 of SHAPE represents a human body shape. The global displacement is a three-dimensional space position of the human body in a frame in the world coordinate system defined by the model. Subsequently, the SMPL model can calculate and obtain spatial positions of 24 key points of the human body in the SMPL coordinate system through the POSE and the SHAPE, and the spatial positions are added with the global displacement to obtain global spatial positions of the key points of the human body. The spatial positions of the key points of the human body can be used to calculate a space vector of a section of body skeleton, so as to calculate a space included angle of a bone connection point, namely a human joint. Next, a global displacement difference between a frame and a previous frame in the time sequence is divided by a sampling interval time of the camera, to obtain the body moving velocity in the frame. Similarly, the moving velocity of the key point of the body and the angular velocity of the body joint can be obtained by using the calculated global key point spatial position of the body and the spatial included angle of the body joint.

Furthermore, key motion partitioning of the motion evaluation may be performed. Illustratively, the TGMD standing long jump standard divides the standing long jump into four parts, i.e., the preparatory motion, the take-off motion, the flight motion and the landing motion. For the take-off motion, the k-th frame is found from body reconstruction and physical quantity calculation results, and if, from the frame, the moving velocities of the next continuous 5 frames are higher than an average velocity of all the previous frames, the k-th frame can be judged to be the take-off motion frame. For the preparatory motion, the frame m with the minimum average joint angle of the knees is found forward from the take-off motion as the preparatory motion frame. For the flight motion, the frame j with the highest motion of the body spatial position on the z axis is found as the flight motion frame. For the landing motion, the n-th frame is found backwards from the frame j, and if, from the frame, the moving velocities of the next continuous 5 frames are smaller than an average speed of the previous frames ending to the frame k, the n-th frame is the landing motion frame.

Furthermore, the key motion frame can be evaluated.

Specifically, FIG. 2 shows a schematic diagram of a preparatory motion frame according to the embodiment of the present disclosure. As shown in FIG. 2, two knee joints are at an angle of 112°, and both arms are behind the trunk and at an angle of 41.7° with respect to the trunk. It is determined that the included angle threshold of the knee joint is not more than 120° and the two arms are behind the trunk and at an included angle threshold of not less than 20° with respect to the trunk according to the standard preparatory pose parameter. At this time, the generated preparatory motion evaluation result may be: qualified. Illustratively, when the included angle of the two knee joints is greater than 120° and does not meet the included angle threshold of the knee joint in the standard preparatory pose parameter, the generated preparatory motion evaluation result may be: squatting amplitude is insufficient when ready for jumping; when the arms are not behind the trunk or are at an angle of more than 20° with respect to the trunk, the generated preparatory motion evaluation result may be: arms should be behind body when ready for jumping. In particular, when both conditions are not satisfied, the generated preparatory motion evaluation result may merge the two evaluation results.

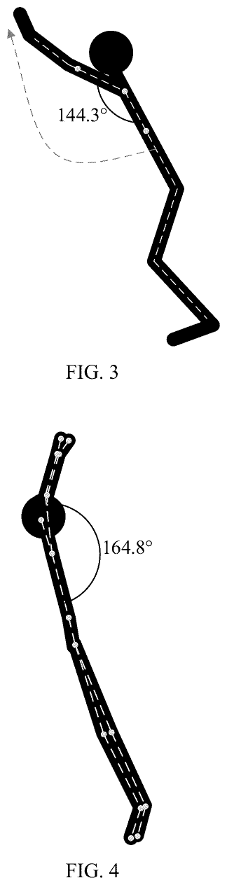

Specifically, FIG. 3 shows a schematic diagram of a take-off motion frame according to the embodiment of the present disclosure. As shown in FIG. 3, an included angle between the arm and the trunk is 144.3°, a spatial included angle between the arm and the trunk is gradually increased from 3 frames before the frame in the time sequence to the frame, and a rate of coincidence of two feet is consistent. It is determined that the two arms are in front of the trunk and at an included angle threshold of not less than 120° with respect to the trunk and the velocity difference threshold of the two feet is not higher than 0.1 m/s according to the standard take-off pose parameter. At this time, the generated preparatory motion evaluation result may be: qualified. Illustratively, when the included angle between the arm and the trunk is less than 120° and does not meet the included angle threshold between the arm and the trunk in the standard take-off pose parameter, the generated take-off motion evaluation result may be: arm should stretch forwards with force when jumping; when the spatial included angle between the arm and the trunk is gradually decreased or unchanged from the first 3 frames of the frame in the time sequence to the frame, the generated take-off motion evaluation result may be: arm should swing forwards with force when jumping; when the velocity difference of the feet is greater than 0.1 m/s and does not meet the velocity difference threshold in the standard take-off pose parameter, the generated evaluation result may be: both feet should take off simultaneously. In particular, when none of the three conditions is satisfied, the generated preparatory motion evaluation result may merge the three evaluation results.

Specifically, FIG. 4 shows a schematic diagram of a flight motion frame according to an embodiment of the present disclosure. As shown in FIG. 4, an included angle between the arm and the trunk is 164.8°, and the hands are above the head. It is determined that the included angle threshold between the arm and the trunk is not less than 160° and the hands are above the head according to the standard flight pose parameter. At this time, the generated preparatory motion evaluation result may be: qualified. Illustratively, when the included angle between the arm and the trunk is less than 160° and does not meet the included angle threshold between the arm and the trunk in the standard flight pose parameter, the generated flight motion evaluation result may be: hands should be raised over head in air.

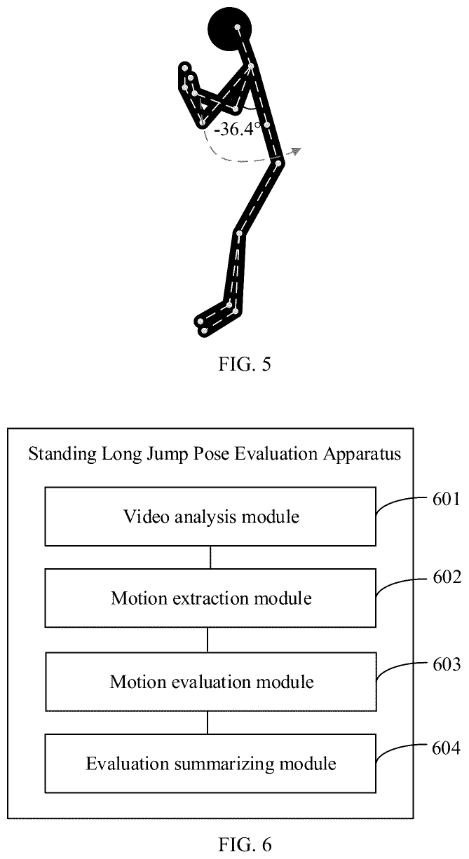

Specifically, FIG. 5 shows a schematic diagram of a landing motion frame according to an embodiment of the present disclosure. As shown in FIG. 5, the angular velocity direction of the included angle between the arm and the trunk is vertical and outward from the frame to the last 3 frames after the frame in the time sequence, and the velocity difference between the two feet is 0.1 m/s. It is determined that the angular velocity direction is vertical and outward, and the velocity difference between the two feet is not more than 0.15 m/s according to the standard flight pose parameter. At this time, the generated preparatory motion evaluation result may be: qualified. Illustratively, when the angular velocity direction of the included angle between the arm and the trunk is vertical and inward from the frame to 3 frames after the frame in the time sequence or the angular velocity is 0, the generated landing motion evaluation result may be: hands should swing downwards with force when landing; when the velocity difference between the two feet is greater than 0.15 m/s, the generated landing motion evaluation result may be: both feet should land simultaneously. In particular, when both conditions are not satisfied, the generated preparatory motion evaluation result may merge the two evaluation results.

It should be understood that the schematic diagrams shown in FIGS. 2 to 5 are merely exemplary and not restrictive, and that they are extensible. Various obvious changes and/or substitutions may be made by those skilled in the art based on the examples of FIGS. 2 to 5, and still fall within the scope of the disclosure of the embodiments of the disclosure.

An embodiment of the present disclosure provides an apparatus of evaluating pose in standing long jump. As shown in FIG. 6, the apparatus includes: a video analysis module 601 configured to generate, for a video frame in a standing long jump video of a target object, a body spatial position, a joint angle, a relative position parameter of a body part and a body moving velocity of the target object in the video frame using a body pose estimation method; a motion extraction module 602 configured to extract a plurality of key motion frames from the standing long jump video according to the body spatial position, the body moving velocity and the joint angle of the target object in video frames; a motion evaluation module 603 configured to obtain a key motion evaluation result of the target object in a key motion frame according to a preset standard pose parameter, and the relative position parameter of the body part, the body moving velocity and the joint angle of the target object in the key motion frame; and an evaluation summarizing module 604 configured to determine a standing long jump pose evaluation result for the target object according to the key motion evaluation result of the target object.

In some embodiments, the video analysis module 601 includes: a model generation submodule configured to generate, for the video frame, a body parameterized model and the body spatial position of the target object in the video frame using the body pose estimation method; a parameter calculation submodule configured to determine a key point spatial position, the joint angle and the relative position parameter of the body part in the video frame according to the body parameterized model and the body spatial position; a velocity calculation submodule configured to determine the body moving velocity in the video frame based on a sampling parameter according to the key point spatial position.

In some embodiments, the parameter calculation submodule is configured to determine a pose parameter and a body shape parameter according to the body parameterized model; determine the key point spatial position according to the pose parameter, the body shape parameter and the body spatial position; determine a body skeleton vector according to the key point spatial position; and determine the joint angle and the relative position parameter of the body part according to the body skeleton vector.

In some embodiments, the key motion frame includes a preparatory motion frame, a take-off motion frame, a flight motion frame, and a landing motion frame; an motion extraction module 602 includes: a preparatory motion frame extraction submodule configured to extract a preparatory motion frame from the standing long jump video according to the joint angle of the target object in the video frames; a take-off motion frame extraction submodule configured to extract a take-off motion frame from the standing long jump video according to the body moving velocity of the target object in the video frames; a flight motion frame extraction submodule configured to extract a flight motion frame from the standing long jump video according to the body spatial position of the target object in the video frames; and a landing motion frame extraction submodule configured to extract a landing motion frame from the standing long jump video according to the body moving velocity of the target object in the video frame and the take-off motion frames.

In some embodiments, the motion evaluation module 603 includes: a pose determination submodule configured to determine body pose data of the target object in the key motion frame according to the relative position parameter of the body part, the body moving velocity and the joint angle; and a pose evaluation submodule configured to compare the body pose data with the standard pose parameter to obtain the key motion evaluation result of the target object in the key motion frame.

In some embodiments, the pose determination submodule is configured to determine the body pose data of the target object in the preparatory motion frame according to the joint angle and the relative position parameter of the body part; determine the body pose data of the target object in the take-off motion frame according to the relative position parameter of the body part and the body moving velocity; determine the body pose data of the target object in the flight motion frame according to the relative position parameter of the body part; and determine the body pose data of the target object in the landing motion frame according to the relative position parameter of the body part and the body moving velocity.

In some embodiments, the standard pose parameter includes at least a standard takeoff pose parameter, a standard preparatory pose parameter, a standard flight pose parameter, and a standard landing pose parameter; and the pose evaluation submodule is configured to compare the body pose data of the target object in the preparatory motion frame with the standard preparatory pose parameter to obtain the key motion evaluation result of the target object in the preparatory motion frame; compare the body pose data of the target object in the take-off motion frame with the standard take-off pose parameter to obtain the key motion evaluation result of the target object in the take-off motion frame; compare the body pose data of the target object in the flight motion frame with the standard flight pose parameter to obtain the key motion evaluation result of the target object in the flight motion frame; and compare the body pose data of the target object in the landing motion frame with the standard landing pose parameter to obtain the key motion evaluation result of the target object in the landing motion frame.

In some embodiments, the key motion evaluation result includes at least “qualified” or a correction suggestion; the evaluation summarizing module 604 includes: the suggestion extraction submodule is configured to traverse key motion evaluation results of the target object and extract the correction suggestion in the key motion evaluation results; and the result generation submodule is configured to generate the standing long jump pose evaluation result according to the correction suggestion and the key motion corresponding to the correction suggestion.

In some embodiments, the apparatus of evaluating the pose in the standing long jump further includes: a result weighting module 605 (not shown in FIG. 6) configured to weight the key motion evaluation result according to a confidence parameter output by the body pose estimation method to generate a weighted key motion evaluation result, where the confidence parameter represents an estimation reliability of the body parameterized model and the key point spatial position.

In some embodiments, the motion evaluation module 603 further includes a landing parameter calculation submodule configured to calculate a gravity center trajectory after landing and a touchdown time according to the body spatial positions of continuous frames; a stability evaluation submodule configured to generate a landing stability evaluation result according to a deviation amplitude and direction of the gravity center trajectory and the touchdown time and by combining a preset landing stability standard parameter; and a stability result merging submodule configured to add the landing stability evaluation result to the key motion evaluation result corresponding to the landing motion frame.

In some embodiments, the apparatus of evaluating the pose in the standing long jump further includes: an interval calculation module 606 (not shown in FIG. 6) configured to calculate a motion transition time interval between adjacent key motions according to the time sequence of the preparatory motion frame, the take-off motion frame, the flight motion frame and the landing motion frame; a consistency evaluation module 607 (not shown in FIG. 6) configured to generate an motion consistency evaluation result by combining a preset standard motion consistency parameter according to the motion transition time interval and a change rate of the joint angle between corresponding motion frames; a consistency result merging module 608 (not shown in FIG. 6) configured to merge the motion consistency evaluation result into the standing long jump pose evaluation result.

In some embodiments, the standing long jump video is captured by a monocular camera at a fixed position.

For a description of specific functions and examples of each module and each submodule of the apparatus according to the embodiments of the present disclosure, reference may be made to the related description of the corresponding steps in the foregoing method embodiments, and details thereof are not repeated herein.

The apparatus of evaluating the pose in the standing long jump according to the embodiments of the present disclosure can analyze and acquire various body motion data only by using the standing long jump video through the body pose estimation process without wearable sensor equipment, and can be applied to body motion analysis in different scenarios. The extraction of the key motion frame can reduce the data redundancy, focus on the key motion node of movement while providing the information of important motion, provide support for pose analysis. The generation of the key motion evaluation result can provide the quality evaluation for each key motion. The generation of the standing long jump pose evaluation result can provide the overall performance evaluation and help the user to know the movement quality.

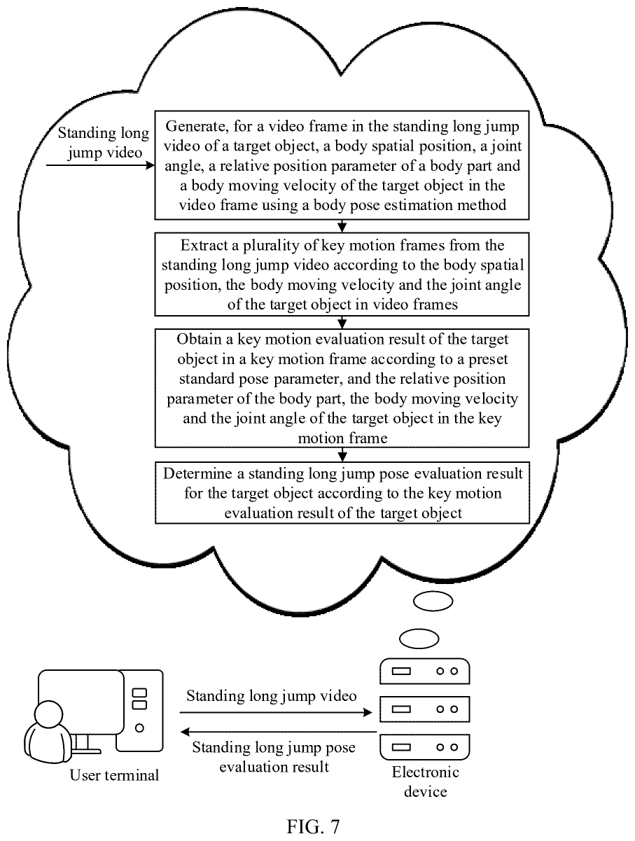

The embodiment of the present disclosure provides a schematic diagram illustrating a scenario of the method of evaluating the pose in the standing long jump, as shown in FIG. 7.

As described above, the method of evaluating the pose in the standing long jump according to the embodiment of the present disclosure is applied to an electronic device. The electronic device is intended to represent various forms of digital computers, such as a laptop, a desktop, a workstation, a personal digital assistant, a server, a blade server, a mainframe and other suitable computers.

Specifically, the electronic device may specifically perform the following operations:
generating, for a video frame in a standing long jump video of a target object, a body spatial position, a joint angle, a relative position parameter of a body part and a body moving velocity of the target object in the video frame using a body pose estimation method; extracting a plurality of key motion frames from the standing long jump video according to the body spatial position, the body moving velocity and the joint angle of the target object in video frames; obtaining a key motion evaluation result of the target object in a key motion frame according to a preset standard pose parameter, and the relative position parameter of the body part, the body moving velocity and the joint angle of the target object in the key motion frame; and determining a standing long jump pose evaluation result for the target object according to the key motion evaluation result of the target object.

It should be understood that the scenario diagram shown in FIG. 7 is only illustrative and not restrictive. Those skilled in the art may make various obvious changes and/or substitutions based on the example of FIG. 7, and the obtained technical solutions still fall into the scope of the embodiments of the present disclosure.

In the technical solution of the present disclosure, the acquisition, storage and application of the user's personal information involved are all in compliance with the provisions of relevant laws and regulations, and do not violate public order and good customs.

According to the embodiments of the present disclosure, the present disclosure also provides an electronic device, a readable storage medium and a computer program product.

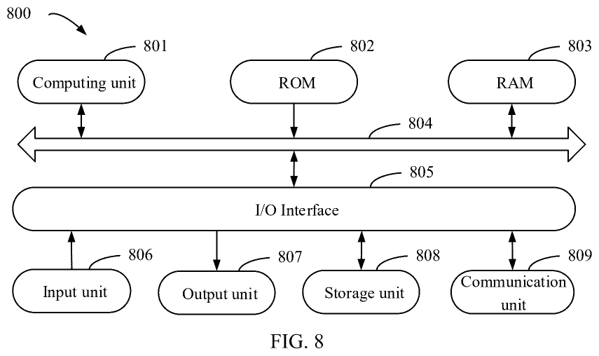

FIG. 8 shows a schematic block diagram of an exemplary electronic device 800 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital assistant, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 8, the device 800 includes a computing unit 801 that may perform various appropriate actions and processes according to a computer program stored in a Read-Only Memory (ROM) 802 or a computer program loaded from a storage unit 808 into a Random Access Memory (RAM) 803. Various programs and data required for an operation of device 800 may also be stored in the RAM 803. The computing unit 801, the ROM 802 and the RAM 803 are connected to each other through a bus 804. The input/output (I/O) interface 805 is also connected to the bus 804.

A plurality of components in the device 800 are connected to the I/O interface 805, and include an input unit 806 such as a keyboard, a mouse, or the like; an output unit 807 such as various types of displays, speakers, or the like; the storage unit 808 such as a magnetic disk, an optical disk, or the like; and a communication unit 809 such as a network card, a modem, a wireless communication transceiver, or the like. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 801 performs various methods and processing described above, such as the above method of evaluating the pose in the standing long jump. For example, in some implementations, the above method of evaluating the pose in the standing long jump may be implemented as a computer software program tangibly contained in a computer-readable medium, such as the storage unit 808. In some implementations, a part or all of the computer program may be loaded and/or installed on the device 800 via the ROM 802 and/or the communication unit 809. When the computer program is loaded into RAM 803 and executed by the computing unit 801, one or more steps of the method of evaluating the pose in the standing long jump described above may be performed. Alternatively, in other implementations, the computing unit 801 may be configured to perform the above method of evaluating the pose in the standing long jump by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), Application Specific Standard Parts (ASSP), a System on Chip (SOC), a Complex Programmable Logic Device (CPLD), a computer hardware, firmware, software, and/or a combination thereof. These various implementations may be implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

The program code for implementing the method of the present disclosure may be written in any combination of one or more programming languages. The program code may be provided to a processor or controller of a general-purpose computer, a special-purpose computer or other programmable data processing devices, which enables the program code, when executed by the processor or controller, to cause the function/operation specified in the flowchart and/or block diagram to be implemented. The program code may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to the user; and a keyboard and a pointing device (e.g., a mouse or a trackball) through which the user may provide input to the computer. Other types of devices may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system (which serves as, for example, a data server) including a back-end component, or in a computing system (which serves as, for example, an application server) including a middleware, or in a computing system including a front-end component (e.g., a user computer with a graphical user interface or web browser through which the user may interact with the implementation of the system and technologies described herein), or in a computing system including any combination of the back-end component, the middleware component, or the front-end component. The components of the system may be connected to each other through any form or kind of digital data communication (e.g., a communication network). Examples of the communication network include a Local Area Network (LAN), a Wide Area Network (WAN), and the Internet.

A computer system may include a client and a server. The client and server are generally far away from each other and usually interact with each other through a communication network. A relationship between the client and the server is generated by computer programs running on corresponding computers and having a client-server relationship with each other. The server may be a cloud server, a distributed system server, or a blockchain server.

It should be understood that, the steps may be reordered, added or removed by using the various forms of the flows described above. For example, the steps recorded in the present disclosure can be performed in parallel, in sequence, or in different orders, as long as a desired result of the technical scheme disclosed in the present disclosure can be realized, which is not limited herein.

The foregoing specific implementations do not constitute a limitation on the protection scope of the present disclosure. Those having ordinary skill in the art should understand that, various modifications, combinations, sub-combinations and substitutions may be made according to a design requirement and other factors. Any modification, equivalent replacement, improvement or the like made within the spirit and principle of the present disclosure shall be included in the protection scope of the present disclosure.

What is claimed is:

1. A method of evaluating pose in standing long jump, comprising:
generating, for a video frame in a standing long jump video of a target object, a body spatial position, a joint angle, a relative position parameter of a body part and a body moving velocity of the target object in the video frame using a body pose estimation method;
extracting a plurality of key motion frames from the standing long jump video according to the body spatial position, the body moving velocity and the joint angle of the target object in video frames;
obtaining a key motion evaluation result of the target object in a key motion frame according to a preset standard pose parameter, and the relative position parameter of the body part, the body moving velocity and the joint angle of the target object in the key motion frame; and
determining a standing long jump pose evaluation result for the target object according to the key motion evaluation result of the target object.

2. The method of claim 1, wherein generating, for the video frame in the standing long jump video of the target object, the body spatial position, the joint angle, the relative position parameter of the body part, and the body moving velocity of the target object in the video frame using the body pose estimation method comprises:
generating, for the video frame, a body parameterized model and the body spatial position of the target object in the video frame using the body pose estimation method;
determining a key point spatial position, the joint angle and the relative position parameter of the body part in the video frame according to the body parameterized model and the body spatial position; and
determining the body moving velocity in the video frame based on a sampling parameter according to the key point spatial position.

3. The method of claim 2, wherein determining the key point spatial position, the joint angle and the relative position parameter of body part in the video frame according to the body parameterized model and the body spatial position comprises:
determining a pose parameter and a body shape parameter according to the body parameterized model;
determining the key point spatial position according to the pose parameter, the body shape parameter and the body spatial position;
determining a body skeleton vector according to the key point spatial position; and
determining the joint angle and the relative position parameter of the body part according to the body skeleton vector.

4. The method of claim 1, wherein the key motion frame includes at least a preparatory motion frame, a take-off motion frame, a flight motion frame, and a landing motion frame;
extracting the plurality of key motion frames from the standing long jump video according to the body spatial position, the body moving velocity and the joint angle of the target object in the video frame comprises:
extracting a preparatory motion frame from the standing long jump video according to the joint angle of the target object in the video frames;
extracting a take-off motion frame from the standing long jump video according to the body moving velocity of the target object in the video frame;
extracting a flight motion frame from the standing long jump video according to the body spatial position of the target object in the video frame; and
extracting a landing motion frame from the standing long jump video according to the body moving velocity of the target object in the video frame and the take-off motion frame.

5. The method of claim 4, wherein obtaining the key motion evaluation result of the target object in the key motion frame according to the preset standard pose parameter and the relative position parameter of the body part, the body moving velocity and the joint angle of the target object in the key motion frame comprises:
determining body pose data of the target object in the key motion frame according to the relative position parameter of the body part, the body moving velocity and the joint angle; and
comparing the body pose data with the standard pose parameter to obtain the key motion evaluation result of the target object in the key motion frame.

6. The method of claim 5, wherein determining the body pose data of the target object in the key motion frame according to the relative position parameter of the body part, the body moving velocity and the joint angle comprises:
determining the body pose data of the target object in the preparatory motion frame according to the joint angle and the relative position parameter of the body part;
determining the body pose data of the target object in the take-off motion frame according to the relative position parameter of the body part and the body moving velocity;
determining the body pose data of the target object in the flight motion frame according to the relative position parameter of the body part; and
determining the body pose data of the target object in the landing motion frame according to the relative position parameter of the body part and the body moving velocity.

7. The method of claim 6, wherein the standard pose parameter includes at least a standard take-off pose parameter, a standard preparatory pose parameter, a standard flight pose parameter, and a standard landing pose parameter;
comparing the body pose data with the standard pose parameter to obtain the key motion evaluation result of the target object in the key motion frame, comprises:
comparing the body pose data of the target object in the preparatory motion frame with the standard preparatory pose parameter to obtain the key motion evaluation result of the target object in the preparatory motion frame;
comparing the body pose data of the target object in the take-off motion frame with the standard take-off pose parameter to obtain the key motion evaluation result of the target object in the take-off motion frame;
comparing the body pose data of the target object in the flight motion frame with the standard flight pose parameter to obtain the key motion evaluation result of the target object in the flight motion frame; and
comparing the body pose data of the target object in the landing motion frame with the standard landing pose parameter to obtain the key motion evaluation result of the target object in the landing motion frame.

8. The method of claim 1, wherein the key motion evaluation result includes at least “qualified” or the correction suggestion;
determining the standing long jump pose evaluation result for the target object according to the key motion evaluation result of the target object comprises:
traversing key motion evaluation results of the target object and extracting the correction suggestion in the key motion evaluation results; and
generating the standing long jump pose evaluation result according to the correction suggestion and the key motion corresponding to the correction suggestion.

9. The method of claim 2, wherein after obtaining the key motion evaluation result of the target object in the key motion frame according to the preset standard pose parameter and the relative position parameter of the body part, the body moving velocity and the joint angle of the target object in the key motion frame, the method further comprises:
weighting the key motion evaluation result according to a confidence parameter output by the body pose estimation method to generate a weighted key motion evaluation result,
wherein the confidence parameter represents an estimation reliability of the body parameterized model and the key point spatial position.

10. The method of claim 4, wherein obtaining the key motion evaluation result of the target object in the key motion frame according to the preset standard pose parameter and the relative position parameter of the body part, the body moving velocity and the joint angle of the target object in the key motion frame further comprises:
in the landing motion frame, calculating a gravity center trajectory after landing and a touchdown time according to the body spatial positions of continuous frames;
generating a landing stability evaluation result according to a deviation amplitude and direction of the gravity center trajectory and the touchdown time and by combining a preset landing stability standard parameter; and
adding the landing stability evaluation result to the key motion evaluation result corresponding to the landing motion frame.

11. The method of claim 4, wherein the method further comprises:
calculating a motion transition time interval between adjacent key motions according to the time sequence of the preparatory motion frame, the take-off motion frame, the flight motion frame and the landing motion frame;
generating a motion consistency evaluation result by combining a preset standard motion consistency parameter according to the motion transition time interval and a change rate of the joint angle between corresponding motion frames; and
merging the motion consistency evaluation result into the standing long jump pose evaluation result.

12. The method of claim 1, wherein the standing jump video is captured by a monocular camera at a fixed position.

13. An electronic device, comprising:
at least one processor; and
a memory connected in communication with the at least one processor,
wherein the memory stores an instruction executable by the at least one processor, and the instruction, when executed by the at least one processor, enables the at least one processor to execute operations, comprising:
generating, for a video frame in a standing long jump video of a target object, a body spatial position, a joint angle, a relative position parameter of a body part and a body moving velocity of the target object in the video frame using a body pose estimation method;
extracting a plurality of key motion frames from the standing long jump video according to the body spatial position, the body moving velocity and the joint angle of the target object in video frames;
obtaining a key motion evaluation result of the target object in a key motion frame according to a preset standard pose parameter, and the relative position parameter of the body part, the body moving velocity and the joint angle of the target object in the key motion frame; and
determining a standing long jump pose evaluation result for the target object according to the key motion evaluation result of the target object.

14. The electronic device of claim 13, wherein generating, for the video frame in the standing long jump video of the target object, the body spatial position, the joint angle, the relative position parameter of the body part, and the body moving velocity of the target object in the video frame using the body pose estimation method comprises:
generating, for the video frame, a body parameterized model and the body spatial position of the target object in the video frame using the body pose estimation method;
determining a key point spatial position, the joint angle and the relative position parameter of the body part in the video frame according to the body parameterized model and the body spatial position; and
determining the body moving velocity in the video frame based on a sampling parameter according to the key point spatial position.

15. The electronic device of claim 14, wherein determining the key point spatial position, the joint angle and the relative position parameter of body part in the video frame according to the body parameterized model and the body spatial position comprises:
determining a pose parameter and a body shape parameter according to the body parameterized model;
determining the key point spatial position according to the pose parameter, the body shape parameter and the body spatial position;
determining a body skeleton vector according to the key point spatial position; and
determining the joint angle and the relative position parameter of the body part according to the body skeleton vector.

16. The electronic device of claim 13, wherein the key motion frame includes at least a preparatory motion frame, a take-off motion frame, a flight motion frame, and a landing motion frame;
extracting the plurality of key motion frames from the standing long jump video according to the body spatial position, the body moving velocity and the joint angle of the target object in the video frame comprises:
extracting a preparatory motion frame from the standing long jump video according to the joint angle of the target object in the video frames;
extracting a take-off motion frame from the standing long jump video according to the body moving velocity of the target object in the video frame;
extracting a flight motion frame from the standing long jump video according to the body spatial position of the target object in the video frame; and
extracting a landing motion frame from the standing long jump video according to the body moving velocity of the target object in the video frame and the take-off motion frame.

17. A non-transitory computer readable storage medium storing a computer instruction wherein the computer instruction causes a computer to perform operations, comprising:
generating, for a video frame in a standing long jump video of a target object, a body spatial position, a joint angle, a relative position parameter of a body part and a body moving velocity of the target object in the video frame using a body pose estimation method;
extracting a plurality of key motion frames from the standing long jump video according to the body spatial position, the body moving velocity and the joint angle of the target object in video frames;
obtaining a key motion evaluation result of the target object in a key motion frame according to a preset standard pose parameter, and the relative position parameter of the body part, the body moving velocity and the joint angle of the target object in the key motion frame; and
determining a standing long jump pose evaluation result for the target object according to the key motion evaluation result of the target object.

18. The non-transitory computer readable storage medium of claim 17, wherein generating, for the video frame in the standing long jump video of the target object, the body spatial position, the joint angle, the relative position parameter of the body part, and the body moving velocity of the target object in the video frame using the body pose estimation method comprises:
generating, for the video frame, a body parameterized model and the body spatial position of the target object in the video frame using the body pose estimation method;
determining a key point spatial position, the joint angle and the relative position parameter of the body part in the video frame according to the body parameterized model and the body spatial position; and
determining the body moving velocity in the video frame based on a sampling parameter according to the key point spatial position.

19. The non-transitory computer readable storage medium of claim 18, wherein determining the key point spatial position, the joint angle and the relative position parameter of body part in the video frame according to the body parameterized model and the body spatial position comprises:
determining a pose parameter and a body shape parameter according to the body parameterized model;
determining the key point spatial position according to the pose parameter, the body shape parameter and the body spatial position;
determining a body skeleton vector according to the key point spatial position; and
determining the joint angle and the relative position parameter of the body part according to the body skeleton vector.

20. The non-transitory computer readable storage medium of claim 17, wherein the key motion frame includes at least a preparatory motion frame, a take-off motion frame, a flight motion frame, and a landing motion frame;
extracting the plurality of key motion frames from the standing long jump video according to the body spatial position, the body moving velocity and the joint angle of the target object in the video frame comprises:
extracting a preparatory motion frame from the standing long jump video according to the joint angle of the target object in the video frames;
extracting a take-off motion frame from the standing long jump video according to the body moving velocity of the target object in the video frame;
extracting a flight motion frame from the standing long jump video according to the body spatial position of the target object in the video frame; and
extracting a landing motion frame from the standing long jump video according to the body moving velocity of the target object in the video frame and the take-off motion frame.
